(19) United States
(12) Patent Application Publication
(10) Pub. No.: US 2026/0349891 A1
(43) Pub. Date: Nov. 5, 2026

(54) COMMUNICATION METHOD AND SYSTEM BETWEEN TEST BOARD AND OPTICAL MODULE BASED ON I3C PROTOCOL

(71) Applicant: EOPTOLINK TECHNOLOGY INC., LTD, Chengdu City (CN)

(72) Inventors: Xiaolei Huang, Chengdu City (CN); Shenggang Huang, Chengdu City (CN); Jun Cao, Chengdu City (CN); Pengfei He, Chengdu City (CN); Fabin Wang, Chengdu City (CN)

(21) Appl. No.: 19/660,221

(22) Filed: Apr. 27, 2026

(30) Foreign Application Priority Data
Apr. 30, 2025 (CN) 202510558811.1

(51) Int. Cl. G06F 11/273; G06F 11/22; G06F 13/42

(52) U.S. Cl. CPC G06F 11/2733; G06F 11/2221; G06F 13/4291

(57) ABSTRACT

Provided are communication method and system between test board and optical module based on I3C protocol. The method includes: receiving, by test board, instruction sent by upper computer; configuring DMA channel of test board and I3C bus; selecting, by test board, transmitting FIFO, adjusting FIFO threshold according to data volume of instruction, and sending write command to optical module through I3C bus when instruction being write instruction; performing, by optical module, operation according to write command when receiving write command; selecting, by test board, receiving FIFO, adjusting FIFO threshold according to data volume of instruction, and sending read command to optical module through I3C bus when instruction being read instruction; returning, by optical module, data to test board according to read command when receiving read command; performing, by test board, error handling operation when optical module not receiving write or read command, or not receiving or outputting correct data.

### CROSS-REFERENCE TO RELATED APPLICATIONS

The present disclosure claims the priority to the Chinese patent application No. 202510558811.1 filed with the Chinese Patent Office on Apr. 30, 2025, and entitled “COMMUNICATION METHOD AND SYSTEM BETWEEN TEST BOARD AND OPTICAL MODULE BASED ON I3C PROTOCOL”, the contents of which are incorporated herein by reference in entirety.

### TECHNICAL FIELD

The present disclosure relates to a communication technical field, and specifically to a communication method and a system between a test board and an optical module based on an I3C protocol.

### BACKGROUND ART

An optical module serves as a key component in a modern optical communication system, and stability and reliability of performance of the optical module are crucial for operation of an entire system. Therefore, performing effective testing on the optical module becomes one of key steps for ensuring system quality. A traditional communication method of the optical module usually depends on an I2C (Inter-Integrated Circuit) communication protocol for interaction of test data. However, along with growth of optical communication requirements and development of technology, limitations of the I2C protocol in bandwidth and power consumption gradually appear.

Firstly, in terms of bandwidth, a maximum communication rate of the I2C protocol is limited to Fast-Mode Plus (1 Mbps). For application scenarios requiring rapid transmission of large volume of data, such as during firmware updating, an upper computer is used to send data and instructions frame by frame to an optical-module test board via USB (Universal Serial Bus), and the optical-module test board then performs firmware updating with the optical module through I2C based on a CDB (Command Data Block) format. This causes that an entire firmware in a transmission process is divided into multiple data frames, which are forwarded to the test board through USB and then communicated with the module for updating, thereby causing long updating time and low updating efficiency, which obviously cannot meet requirements. Low-speed data exchange efficiency severely constrains the data processing speed during a testing process, causing a prolonged testing time and low efficiency.

Secondly, from a power consumption perspective, relatively high energy consumption of the I2C protocol becomes a problem that cannot be ignored, especially in a case of large-scale device connection. This not only increases operation cost of a system, but also limits expansion capability of devices. In addition, when handling communication errors, a traditional I2C controller often requires manual initialization to restore communication. This process is complicated and time-consuming, further reducing testing efficiency.

For the above challenges, an I3C (Improved Inter-Integrated Circuit) protocol, as an emerging communication standard, provides a higher communication rate than I2C, supports an SDR mode (Single Data Rate) up to 12.5 Mbps and even an HDR-DDR mode (High Data Rate-Double Data Rate) of 25 Mbps, and has lower power consumption and stronger device expansion capability. Even so, when an existing I3C controller attempts communication during a period in which an I3C target device closes an I3C interrupt, the situation that the target device does not respond to the I3C controller occurs, and then communication process is blocked. Reinitialization of the I3C controller is required to restore normal communication, which also affects stability and efficiency of the system.

The so-called “I3C target device closing an I3C interrupt” can be understood as follows: after an I3C target device correctly completes a communication flow according to an I3C MIPI protocol (such as receiving commands and data), the I3C target device cannot send an interrupt signal to an MCU core, and the MCU core cannot therefore acquire completion status of these communication operations. Furthermore, since the MCU core cannot receive the interrupt signal, it cannot trigger a corresponding interrupt service routine (ISR) to execute subsequent control logic based on the MIPI protocol (for example, reading actual lengths of received and transmitted data, and pre-filling data that the I3C target device sends to the I3C controller). This causes that the I3C controller cannot acquire an expected response.

Therefore, provided are a communication method and a system between a test board and an optical module based on an I3C protocol.

### SUMMARY

The objective of the present disclosure is to provide a communication method and a system between a test board and an optical module based on an I3C protocol, which is used to solve the problems of low testing efficiency of the optical module and poor stability of the I3C protocol in optical module testing.

The present disclosure is implemented by the following technical solutions.

A communication method between a test board and an optical module based on an I3C protocol is provided, comprising:

S1, receiving, by the test board, an instruction sent by an upper computer;

S2, configuring a DMA (Direct Memory Access) channel of the test board and configuring an I3C bus;

S3, selecting, by the test board, a transmitting FIFO (First In First Out, First-In-First-Out data storage and buffering mechanism), adjusting a FIFO threshold according to a data volume of the instruction, and sending a write command to the optical module through the I3C bus in response to the instruction being a write instruction;

S4, performing, by the optical module, an operation according to the write command in response to receiving the write command;

S5, selecting, by the test board, a receiving FIFO, adjusting a FIFO threshold according to a data volume of the instruction, and sending a read command to the optical module through the I3C bus in response to the instruction being a read instruction;

S6, returning, by the optical module, data to the test board according to the read command in response to receiving the read command; and

S7, performing, by the test board, an error handling operation in response to the optical module not receiving the write command or the read command, or not receiving or outputting correct data.

Further, the step of configuring the DMA channel specifically comprises:

S21, configuring, on the test board, a DMA channel at a transmit end of the I3C bus;

S211, configuring a DMA direction of the transmit end as memory to peripheral;

S212, configuring a source address mode of the transmitting DMA as self-increment mode;

S213. configuring a destination address mode of the transmitting DMA as fixed mode;

S22, configuring, on the test board, a DMA channel at a receive end of the I3C bus;

S221, configuring a DMA direction of the receive end as peripheral to memory;

S222, configuring a source address mode of the receiving DMA as fixed mode;

S223, configuring a destination address mode of the receiving DMA as self-increment mode;

S23, configuring a control end of the DMA channel of the test board;

S231, configuring a DMA direction of the transmit end as memory to peripheral;

S232, configuring a source address mode of the transmitting DMA as self-increment mode; and

S233, configuring a destination address mode of the transmitting DMA as fixed mode.

Further, the I3C bus supports a dynamic bandwidth and rate adjustment function.

Further, the step of configuring the I3C bus specifically comprises:

S24, configuring the test board as an I3C controller;

S25, configuring I3C bus timing;

S251, setting a communication bandwidth under I3C Push-pull mode;

S252, setting a communication bandwidth under I3C Open-Drain mode; and

S26, setting an SDA (Serial Data Line) high-impedance function.

Further, the step of adjusting the FIFO threshold based on the transmitting FIFO specifically includes:

S31, receiving, by the test board, a write instruction sent by an upper computer through USB;

S32, determining whether the instruction is a small-data-volume write instruction for control or testing;

S321, setting, by the test board, the transmitting FIFO threshold to 1 byte and initiating a small-data-volume write transmission in response to the instruction being a small-data-volume write instruction;

S3211, automatically determining, by hardware, whether the transmitting FIFO has at least 1 byte of free space, and initiating a DMA transferring one byte from a source address to the transmitting FIFO in response to the transmitting FIFO having at least 1 byte of free space;

S3212, determining whether the transfer is correct;

S32121, determining whether the transfer is completed in response to the transfer being correct;

S321211, returning to S3211 in response to the transfer not being completed;

S321212, continuing to wait for a next instruction in response to the transfer being completed;

S32122, performing the error handling operation of S7 in response to the transfer not being correct;

S322, setting, by the test board, the transmitting FIFO threshold to 4bytes and initiating a large-data-volume write instruction transmission in response to the instruction being a large-data-volume write instruction for firmware updating;

S3221, automatically determining, by hardware, whether the transmitting FIFO has at least 4 bytes of free spaces, and initiating a DMA transferring four bytes from a source address to the transmitting FIFO in response to the transmitting FIFO having at least 4 bytes of free spaces;

S3222, determining whether the transfer is correct;

S32221, determining whether the transfer is completed in response to the transfer being correct;

S322211, returning to S3221 in response to the transfer not being completed;

S322212, continuing to wait for a next instruction in response to the transfer being completed; and

S32222, performing the error handling operation of S7 in response to the transfer not being correct.

Further, the write instruction further comprises a bulk firmware update instruction.

Further, performing the bulk firmware update instruction specifically comprises:
a. receiving, by the test board, the bulk firmware update instruction sent by the upper computer through USB;
b. checking whether a firmware to be downloaded already exists in an MCU (Microcontroller Unit) Flash of the test board;
b1, performing following steps in response to the firmware to be downloaded existing in an MCU Flash of the test board:
b11, reading at most, from the Flash each time, a firmware frame having a maximum byte length of an EPL (Extended Payload) extended payload page in a CMIS (Common Management Interface Specification) protocol;
b12, performing CDB firmware updating based on a transmitting FIFO threshold of 4 bytes;
b13, repeating steps b11 and b12 based on the CDB protocol until a completion of the download;
b2, performing following steps in response to the firmware to be downloaded not existing in an MCU Flash of the test board:
b21, preparing to receive a firmware sent by the upper computer and storing the firmware in the MCU Flash; and
b22, continuing to monitor subsequent bulk firmware download instructions.

Further, the step of adjusting the FIFO threshold based on the receiving FIFO specifically includes:

S51, receiving, by the test board, a read instruction sent by an upper computer through USB;

S52, determining whether the instruction is a small-data-volume read instruction;

S521, setting, by the test board, the receiving FIFO threshold to 1 byte and initiating a small-data-volume read instruction transmission in response to the instruction being the small-data-volume read instruction for control or testing;

S5211, automatically determining, by hardware, whether the receiving FIFO has at least 1 byte of free space, and initiating a DMA transferring one byte from the receiving FIFO to a DMA destination address in response to the receiving FIFO having at least 1 byte of free space;

S5212, determining whether the transfer is correct;

S52121, determining whether the transfer is completed in response to the transfer being correct;

S521211, returning to S5211 in response to the transfer not being completed;

S521212, continuing to wait for a next instruction in response to the transfer being completed;

S52122, performing the error handling operation of S7 in response to the transfer not being correct;

S522, setting, by the test board, the receiving FIFO threshold to 4 bytes and initiating a large-data-volume read instruction transmission in response to the instruction being a large-data-volume read instruction for firmware updating;

S5221, automatically determining, by hardware, whether the receiving FIFO has at least 4 bytes of free spaces, and initiating a DMA transferring four bytes from the receiving FIFO to a DMA destination address in response to the receiving FIFO having at least 4 bytes of free spaces;

S5222, determining whether the transfer is correct;

S52221, determining whether the transfer is completed in response to the transfer being correct;

S522211, returning to S5221 in response to the transfer not being completed;

S522212, continuing to wait for a next instruction in response to the transfer being completed; and

S52222, performing the error handling operation of S7 in response to the transfer not being correct.

Further, the step of performing the error handling operation specifically comprises:
clearing a transmitting FIFO of the I3C, clearing a receiving FIFO of the I3C, clearing FIFO threshold adjustments, disabling requests of a DMA control end, disabling a transmitting DMA request, disabling a receiving DMA request, and reinitializing the I3C, wherein the steps are performed sequentially.

Further, the I3C controller determines whether a triggering condition of the error handling operation occurs, and the MCU of the test board executes the error handling operation automatically in response to the triggering condition occurring.

Further, the I3C generates communication frames comprising random write, random read, and current read, and the optical module receives or outputs data according to corresponding communication frame timing, in response to the test board sending a write command or a read command to the optical module through the I3C bus.

Further, a frame format of the random write is: start bit + optical module address + write flag bit + optical module acknowledge bit + optical module register address + parity bit + data 1 + parity bit + … + data N + parity bit + stop bit.

Further, a frame format of the random read is: start bit + optical module address + write flag bit + optical module acknowledge bit + optical module register address + parity bit + repeated start bit + optical module address + read flag bit + optical module acknowledge bit + data 1 + frame termination bit + … + data N + frame termination bit + stop bit.

Further, a frame format of the current read is: start bit + optical module address + read flag bit + optical module acknowledge bit + data 1 + frame termination bit + … + data N + frame termination bit + stop bit.

The technical solutions of the present disclosure have at least the following advantages and beneficial effects.

The present disclosure discloses a communication method and a system between a test board and an optical module based on an I3C protocol. By adopting the I3C protocol, the data communication rate between the test board and the optical module can be effectively improved, thereby solving the problem of low testing efficiency of the optical module. In addition, by distinguishing between the transmitting FIFO and receiving FIFO and adjusting the FIFO thresholds according to the data volume, the stability of data transmission between the test board and the optical module can be enhanced.

### BRIEF DESCRIPTION OF DRAWINGS

FIG. 1 is a schematic diagram of a method flow according to the present disclosure;

FIG. 2 is a flow schematic diagram of a bulk firmware update instruction according to the present disclosure;

FIG. 3 is a schematic diagram of a read-write instruction flow according to the present disclosure; and

FIG. 4 is a schematic diagram of a system structure according to the present disclosure.

### DETAILED DESCRIPTION OF EMBODIMENTS

In order to make the objective, technical solution, and advantages of the present disclosure clearer, the following will provide a clear and complete description of the technical solution in the embodiments of the present disclosure, in conjunction with the drawings in the embodiments of the present disclosure. Obviously, the described embodiments are a part of the embodiments of the present disclosure, rather than all embodiments. The components of embodiments of the present disclosure which are generally described and illustrated in the drawings herein can be arranged and designed in a variety of different configurations.

In one embodiment,

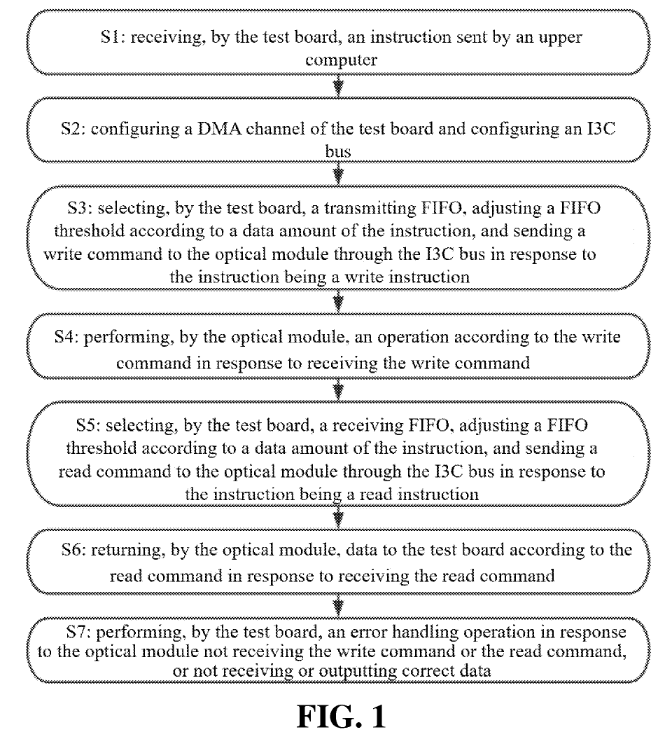

as shown in FIG. 1, a communication method between a test board and an optical module based on an I3C protocol is provided, comprising the following steps.

S1: receiving, by the test board, an instruction sent by an upper computer.

S2: configuring a DMA channel of the test board and configuring an I3C bus. In the step, the adoption of an I3C protocol provides a higher rate compared with the traditional I2C protocol. The I3C protocol can reach up to 12.5 Mbps in the SDR mode and up to 25 Mbps in the HDR-DDR mode, which significantly improves data transmission speed. By using DMA technology, data is directly transferred without intervention of a CPU (Central Processing Unit), thereby reducing the burden on the CPU and enabling the system to process other tasks more efficiently.

By means of DMA technology, when the test board sends data, the data is transferred from the RAM (Random Access Memory) in the MCU of the test board to the I3C peripheral. When the test board receives data, the data is transferred from the I3C peripheral of the MCU of the test board to the RAM of the MCU and is parsed in batches. Based on different testing scenarios, different FIFO threshold settings of the I3C peripheral are used for transmission. When reading a small volume of DDM monitoring information, that is, when executing control or testing instructions, DMA transmission is performed using a FIFO threshold of 1 byte. When performing firmware updates with a large volume of data, DMA transmission is performed using a FIFO threshold of 4 bytes.

It should be noted that data transmission and control between the memory data of the test board and the I3C peripheral adopt a DMA mode. By using DMA, throughput can be enhanced and CPU load can be reduced. A control DMA channel is configured with a high priority, a transmit DMA channel is configured with a medium priority, and a receive DMA channel is configured with a medium priority.

In addition, the I3C protocol supports dynamic adjustment of bandwidth and speed. The test board can select different data transmission rates according to testing requirements and communication capabilities of the tested optical module so as to meet the needs of different testing tasks. For low-speed testing tasks, such as control instructions including temperature data acquisition, a lower communication rate can be adopted. For high-speed tasks, such as optical module firmware updates, read instructions and write instructions including IntLDeassert (Interrupt Low Deassert) status reporting, the rate can be increased to reduce latency.

When assigning a dynamic address to the optical module, the test board can obtain the communication capability of the optical module, including its maximum supported rate, and dynamically configure the communication rate according to requirements.

The configuration supports SDR mode with rates ranging from 100Kbps to 12.5Mbps.

S3: selecting, by the test board, a transmitting FIFO, adjusting a FIFO threshold according to a data volume of the instruction, and sending a write command to the optical module through the I3C bus in response to the instruction being a write instruction.

S4: performing, by the optical module, an operation according to the write command in response to receiving the write command.

S5: selecting, by the test board, a receiving FIFO, adjusting a FIFO threshold according to a data volume of the instruction, and sending a read command to the optical module through the I3C bus in response to the instruction being a read instruction.

S6: returning, by the optical module, data to the test board according to the read command in response to receiving the read command. It should be noted that after receiving returned data, the test board transmits the data back to an upper computer.

S7: performing, by the test board, an error handling operation in response to the optical module not receiving the write command or the read command, or not receiving or outputting correct data.

In addition, the dynamic adjustment of the thresholds of the transmitting FIFO and receiving FIFO according to different data volume requirements improves system flexibility and performance.

In one embodiment,

according to the above embodiment, the I3C generates communication frames comprising random write, random read, and current read, and the optical module receives or outputs data according to corresponding communication frame timing, in response to the test board sending a write command or a read command to the optical module through the I3C bus.

The communication frames of the random write, random read, and current read are all designed based on the Management Memory Map defined by the I3C protocol and the CMIS protocol.

A frame format of the random write is: start bit + optical module address + write flag bit + optical module acknowledge bit + optical module register address + parity bit + data 1 + parity bit + … + data N + parity bit + stop bit.

The data segment “data 1 + parity bit + … + data N + parity bit + stop bit” is optional. If this optional data is not sent, it indicates that the I3C controller on the test board sends only the optical module register address to the optical module through a private write operation, and a private read operation of the I3C controller will be subsequently performed. If the optional data is sent, it indicates that data 1 to data N will be written sequentially starting from the optical module register address.

A frame format of the random read is: start bit + optical module address + write flag bit + optical module acknowledge bit + optical module register address + parity bit + repeated start bit + optical module address + read flag bit + optical module acknowledge bit + data 1 + frame termination bit + … + data N + frame termination bit + stop bit.

The random read includes the optical module register address sent by the private write operation and the private read operation that uses a repeated start bit as a start signal. This indicates that the I3C controller reads data 1 to data N sequentially from the optical module register address.

A frame format of the current read is: start bit + optical module address + read flag bit + optical module acknowledge bit + data 1 + frame termination bit + … + data N + frame termination bit + stop bit.

The current read starts with a start bit, and its timing remains consistent with the latter half of the random read. This indicates that the I3C controller reads data 1 to data N sequentially from the current optical module register address.

Through the above three frame formats—random write, random read, and current read, the test board performs read-write access to the Management Memory Map of the optical module, thereby implementing testing of dynamic address mapping and management defined by the CMIS protocol.

It should be noted that the following explanation is given using the random read frame format as an example.

The meaning of the start bit (START) is as follows:
it is the start condition on the I3C bus and is used to initiate one communication, and it is usually initiated by a master device and indicates the beginning of a new transaction.

The meaning of the optical module address (Address) is as follows:
it is a 7-bit or dynamically assigned I3C device address used to uniquely identify the position of the target slave device, namely the optical module.

The meaning of the write flag bit (WriteBit) is as follows:
a value of 0 indicates that the master device writes data to the slave device, which in this case is the write register address.

The meaning of the optical module acknowledge bit (ACK) is as follows:
it is the response bit of the slave device to the address and direction bit, and a low level indicates successful reception and readiness for communication.

The meaning of the optical module register address (RegisterAddress) is as follows:
it specifies the register address to be read within the slave device, and this address will be used in subsequent reading operations.

The meaning of the parity bit (Paritybit) is as follows:
after the master device writes the optical module register address, one odd parity bit is appended to perform odd parity on the address byte, that is, the total number of “1” in all bits including the parity bit must be odd; and if the odd parity fails, the slave device may not respond or may return an error indication, thereby ensuring communication reliability.

The meaning of the repeated start bit (RepeatedSTART) is as follows:
it restarts a communication frame without sending a STOP, and is used to switch from a write operation to a read operation.

The meaning of the optical module address (Address) is as follows:
the target device address is sent again to prepare for the upcoming read operation.

The meaning of the read flag bit (ReadBit) is as follows:
a value of 1 indicates that the master device reads data from the slave device.

The meaning of the optical module acknowledge bit (ACK) is as follows:
the slave device again acknowledges that it is ready to send data to the master device.

The meaning of data 1 (Data1) is as follows:
it is the first byte of data read from the register and is transmitted by the slave device.

The meaning of the frame termination bit (Tbit) is as follows:
it is a response bit sent by the slave device to notify the master device whether the slave device continues transmitting data; when Tbit is set to 1, it means that the data transmission continues, and transmission ends with a stop signal; and when Tbit is set to 0, it means that the slave device ends data transmission.

The meaning of the Nth data (DataN) is as follows:
it is the last data byte.

The meaning of the stop bit (STOP) is as follows:
it indicates that the current communication is completed and the bus is released.

In one embodiment,

according to the embodiment above, a step of configuring the DMA channel specifically comprises:

S21, configuring, on the test board, a DMA channel at a transmit end of the I3C bus;

S211, configuring a DMA direction of the transmit end as memory to peripheral;

S212, configuring a source address mode of the transmitting DMA as self-increment mode;

S213, configuring a destination address mode of the transmitting DMA as fixed mode;

S22, configuring, on the test board, a DMA channel at a receive end of the I3C bus;

S221, configuring a DMA direction of the receive end as peripheral to memory;

S222, configuring a source address mode of the receiving DMA as fixed mode;

S223, configuring a destination address mode of the receiving DMA as self-increment mode;

S23, configuring a control end of the DMA channel of the test board;

S231, configuring a DMA direction of the transmit end as memory to peripheral;

S232, configuring a source address mode of the transmitting DMA as self-increment mode; and

S233, configuring a destination address mode of the transmitting DMA as fixed mode.

Using DMA technology, when the test board sends data, the data is automatically transferred from the RAM (Random Access Memory) of the test board MCU to the I3C peripheral, and when receiving data, it is automatically transferred from the I3C peripheral of the test board MCU to the RAM of the MCU for batch parsing, without intermediate transfer through the CPU. For test tasks that require processing a large volume of data, such as firmware updates, this greatly improves the efficiency and performance of the system.

In one embodiment,

according to the embodiment above, a step of configuring the I3C bus specifically comprises:

S24, configuring the test board as an I3C controller;

S25, configuring I3C bus timing;

S251, setting communication bandwidth under I3C Pushpull mode;

S252, setting communication bandwidth under I3C OpenDrain mode; and

S26, setting an SDA high-impedance function.

Steps S251 and S252 correspond to the dynamic bandwidth and rate adjustment function of the I3C protocol. According to the requirements of the test task and the communication capability of the tested optical module, different data transmission rates are selected through these two steps to accommodate different test task requirements.

In one embodiment,

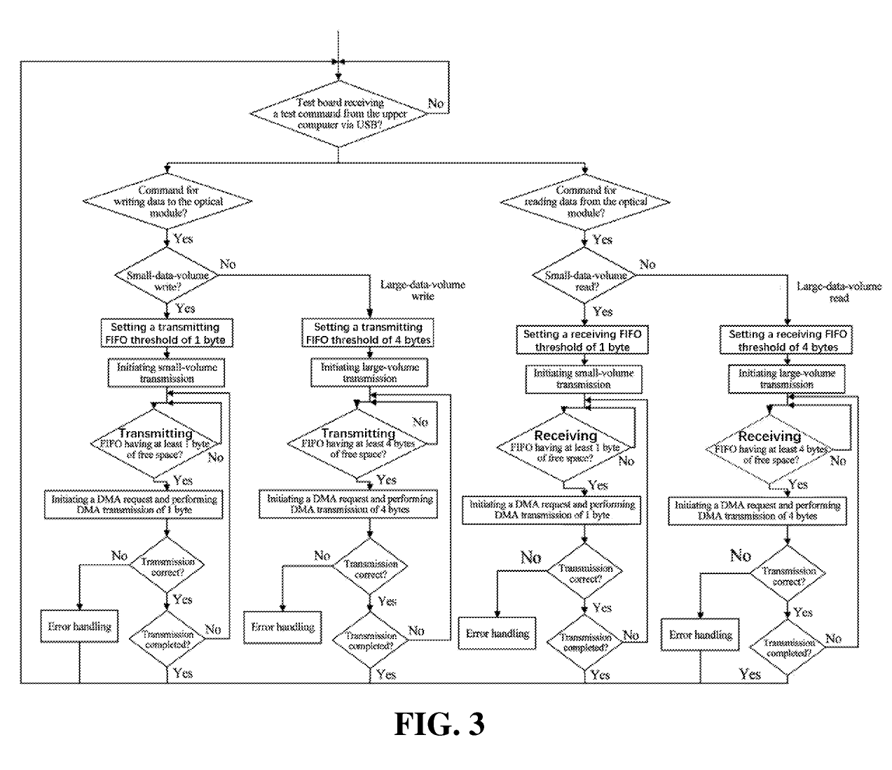

according to the embodiment above and FIG. 3, the steps for adjusting the FIFO threshold based on the transmitting FIFO (TX-FIFO, Transmit First-In-First-Out) are specifically as follows:

S31, receiving, by the test board, a write instruction sent by an upper computer through USB;

S32, determining whether the instruction is a small-data-volume write instruction for control or testing;

S321, setting, by the test board, the transmitting FIFO threshold to 1 byte and initiating a small-data-volume write transmission in response to the instruction being a small-data-volume write instruction;

S3211, automatically determining, by hardware, whether the transmitting FIFO has at least 1 byte of free space, and initiating a DMA transfer of one byte from a source address to the transmitting FIFO in response to the transmitting FIFO having at least 1 byte of free space;

S3212, determining whether the transfer is correct;

S32121, determining whether the transfer is completed in response to the transfer being correct;

S321211, returning to S3211 in response to the transfer not being completed;

S321212, continuing to wait for a next instruction in response to the transfer being completed;

S32122, performing the error handling operation of S7 in response to the transfer not being correct;

S322, setting, by the test board, the transmitting FIFO threshold to 4 bytes and initiating a large-data-volume write instruction transmission in response to the instruction being a large-data-volume write instruction for firmware updating;

S3221, automatically determining, by hardware, whether the transmitting FIFO has at least 4 bytes of free spaces, and initiating a DMA transfer of four bytes from a source address to the transmitting FIFO in response to the transmitting FIFO having at least 4 bytes of free spaces;

S3222, determining whether the transfer is correct;

S32221, determining whether the transfer is completed in response to the transfer being correct;

S322211, returning to S3221 in response to the transfer not being completed;

S322212, continuing to wait for a next instruction in response to the transfer being completed;

S32222, performing the error handling operation of S7 in response to the transfer not being correct.

Additionally, the steps for adjusting the FIFO threshold based on the receiving FIFO (RX-FIFO, Receive First-In-First-Out) are specifically as follows:

S51, receiving, by the test board, a read instruction sent by an upper computer through USB;

S52, determining whether the instruction is a small-data-volume read instruction;

S521, setting, by the test board, the receiving FIFO threshold to 1 byte and initiating a small-data-volume read instruction transmission in response to the instruction being the small-data-volume read instruction for control or testing;

S5211, automatically determining, by hardware, whether the receiving FIFO has at least 1 byte of free space, and initiating a DMA transfer of one byte from the receiving FIFO to a DMA destination address in response to the receiving FIFO having at least 1 byte of free space;

S5212, determining whether the transfer is correct;

S52121, determining whether the transfer is completed in response to the transfer being correct;

S521211, returning to S5211 in response to the transfer not being completed;

S521212, continuing to wait for a next instruction in response to the transfer being completed;

S52122, performing the error handling operation of S7 in response to the transfer not being correct;

S522, setting, by the test board, the receiving FIFO threshold to 4 bytes and initiating a large-data-volume read instruction transmission in response to the instruction being a large-data-volume read instruction for firmware updating;

S5221, automatically determining, by hardware, whether the receiving FIFO has at least 4 bytes of free spaces, and initiating a DMA transfer of four bytes from the receiving FIFO to a DMA destination address in response to the receiving FIFO having at least 4 bytes of free spaces;

S5222, determining whether the transfer is correct;

S52221, determining whether the transfer is completed in response to the transfer being correct;

S522211, returning to S5221 in response to the transfer not being completed;

S522212, continuing to wait for a next instruction in response to the transfer being completed; and

S52222, performing the error handling operation of S7 in response to the transfer not being correct.

The application of the FIFO management mechanism provides an efficient and flexible data transmission mechanism, which is particularly suitable for I3C test boards of optical modules that require execution of various tasks and frequent communication.

In one embodiment,
according to the embodiment above, the instructions include control instructions and test instructions. The control instructions specifically start the optical module to perform operations, and the test instructions include read instructions and write instructions. The read instructions and write instructions are used to control the test board to read data from or write data to the optical module, and the write instructions further include bulk firmware update instructions.

Through the I3C protocol, the test board sends control instructions to the optical module, such as adjusting optical power or collecting test data, and real-time receives feedback data from the optical module, such as temperature or optical power. The control instructions, some read instructions, and some write instructions generally involve small volumes of data; and the bulk firmware update instructions in the write instructions involve firmware upgrades, and the IntLDeassert status reporting in the read instructions involves reading large volumes of data, which thus is the large-data-volume instruction.

In addition, the bulk firmware update instruction is used to perform batch updates of the optical module. The specific update process is as follows.

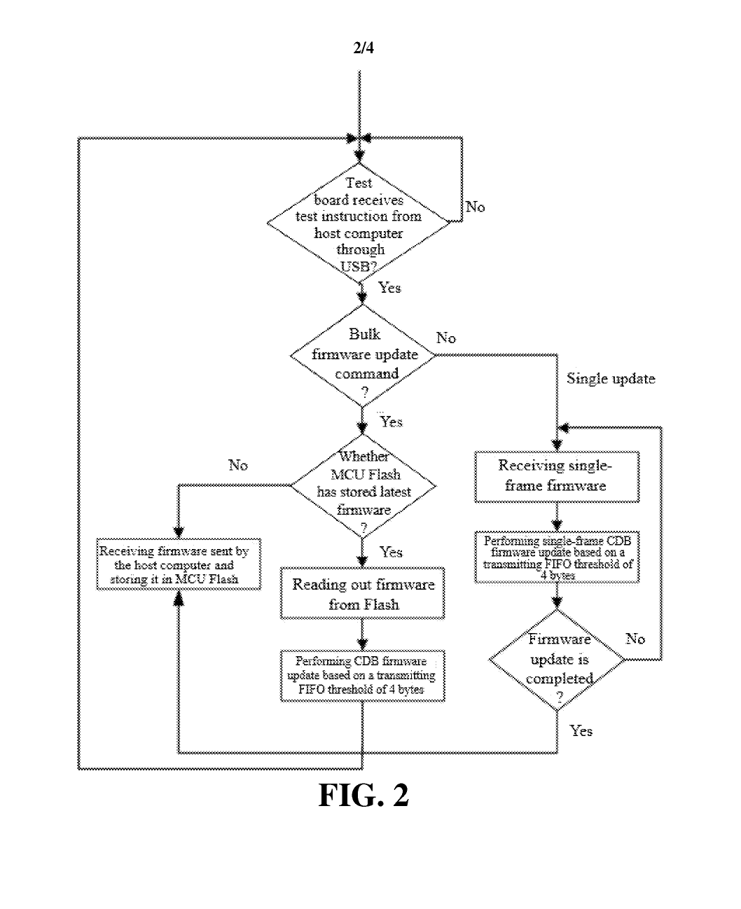

The host computer sends the optical module firmware to the test board via USB, the test board stores the optical module firmware in the Flash of the MCU, and then retrieves the optical module firmware from the Flash through the CDB mechanism in the CMIS protocol and transmits it to the optical module via the I3C bus using DMA, thereby completing the firmware update. During bulk firmware updates, this method can save the time required for the upper computer to transmit the firmware to the test board via USB, thereby reducing the time for bulk firmware updates and improving production efficiency. Referring to FIG. 2, the specific steps are as follows:
a, receiving, by the test board, the bulk firmware download instruction sent by the upper computer through USB;
b, checking whether a firmware to be downloaded already exists in an MCU Flash of the test board;
b1, performing following steps in response to the firmware to be downloaded existing in an MCU Flash of the test board:
b11, reading at most, from the Flash each time, a firmware frame having a maximum byte length of an EPL extended payload page in a CMIS protocol;
b12, performing CDB firmware updating based on a transmitting FIFO threshold of 4 bytes;
b13, repeating steps b11 and b12 based on the CDB protocol until a completion of the download; and
b2, performing following steps in response to the firmware to be downloaded not existing in an MCU Flash of the test board:
b21, preparing to receive a firmware sent by the upper computer and storing the firmware in the MCU Flash; and
b22, continuing to monitor subsequent bulk firmware download instructions.

In one embodiment,
according to any one of the embodiments above, the step of performing the error handling operation specifically comprises:
disabling I3C interrupts, clearing a transmitting FIFO of the I3C, clearing a receiving FIFO of the I3C, clearing FIFO threshold adjustments, disabling requests of a DMA control end, disabling a transmitting DMA request, disabling a receiving DMA request, and reinitializing the I3C, wherein the steps are performed sequentially. In addition, the I3C controller determines whether a triggering condition of the error handling operation occurs, and the MCU of the test board executes the error handling operation automatically in response to the triggering condition occurring. The I3C controller determines a situation in which the write command or read command is not received, or correct data is not received or output. In response, the MCU of the test board automatically executes the specific error handling operation, thereby resolving communication errors. Compared with the conventional approach of manually reinitializing the I3C on the test board, this method greatly improves processing efficiency. It enables rapid and automatic recovery of I3C communication functionality on the test board after communication errors, enhances communication efficiency, and reduces system latency. This is suitable for, including but non-limiting, error recovery in scenarios where I3C interrupts are disabled during programming of the Flash of the I3C optical module.

Moreover, a scenario in which the I3C peripheral terminal is disabled occurs, for example, when the I3C optical module is performing a coding task that requires erasing and programming the Flash. In these cases, the I3C optical module needs to disable some interrupts, including the I3C peripheral interrupt. When the I3C peripheral interrupt of the I3C optical module is disabled and the test board attempts I3C communication with the optical module, the I3C optical module does not respond to the I3C controller, which leads the I3C of the test board to enter an error interrupt.

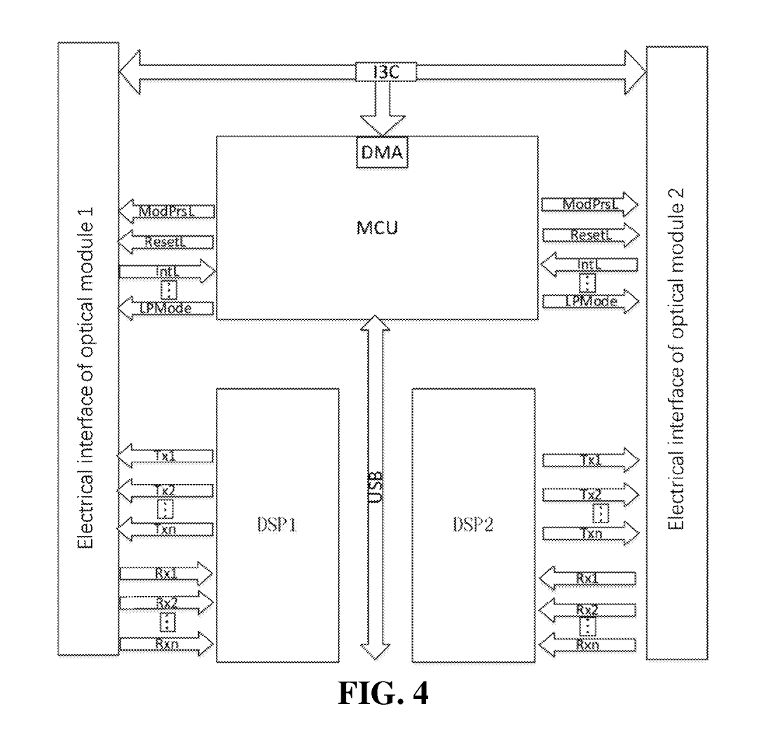

In one embodiment,
according to any one of the above embodiments and with reference to FIG. 4, an optical module testing system based on I3C protocol includes an upper computer, multiple optical modules, and a test board of the multiple optical modules. The upper computer is in signal connection to the test board through USB, and the test board is communicatively connected to the multiple optical modules through the I3C bus.

The optical module can also be referred to as an I3C optical module, and the test board can be referred to as the optical-module test board or I3C optical-module test board. The test board comprises an MCU, a DSP (Digital Signal Processor), optical module electrical interfaces, and a USB interface. The MCU serves as the control center of the test board, responsible for overall coordination to ensure efficient operation of the test board. Its main functions include: 1) sending and receiving commands and data with the upper computer via USB, 2) communicating with the I3C optical modules via the I3C bus on the electrical interface, 3) controlling optical-module-related control pins on the electrical interface, and 4) managing testing tasks.

The DSP is configured to: 1) receive electrical signals generated during optical module testing and perform signal processing and analysis, and 2) send electrical signals required for testing to the optical modules.

The optical-module electrical interface serves as the physical connection between the test board and the optical modules, comprising three types:
(1) multiple low-speed signal control pins, such as Modsel (Module Select, optional), LPMode (Low Power Mode), IntL (Interrupt Low), ResetL (Reset Low), and ModPrsL (Module Present Low, module presence detection signal (active low)), used for module selection, power control, status indication, reset control, and presence status indication;
(2) high-speed data signal pins, including differential signal pairs of transmit end for multiple independent transmitting channels of the optical module, Tx1, Tx2…Txn, and differential signal pairs of receive end for multiple independent receiving channels of the optical module, Rx1, Rx2…Rxn; and
(3) I3C bus including SCL (Serial Clock Line) and SDA (Serial Data Line) for communication between the test board and the I3C optical modules.

The USB interface is configured for connection with USB cable of the upper computer.

Before system operation, all modules are required to be initialized as follows:

S01, initializing low-speed control pins of the optical-module electrical interface;

S02, initializing USB and configuring USB in HID+CDC mode (Human Interface Device + Communication Device Class, a combination of two modes of the USB interface);

S03, initializing Flash, where the Flash serves as a temporary storage area for bulk optical-module firmware download, significantly improving download speed;

S04, performing default initialization of the I3C, initializing the I3C peripheral of the test board as an I3C controller, and configuring DMA communication mode;

S05: initializing peripherals, including ADC (Analog-to-Digital Converter), DAC (Digital-to-Analog Converter), and chips, including DSP, and DC-DC (direct current to direct current) converters; and

S06: beginning test task management, monitoring test commands and data transmission from the host computer via USB.

The above are only preferred embodiments of the present disclosure and are not intended to limit the present disclosure. For those skilled in the art, various modifications and variations can be made to the present disclosure. Any modification, equivalent substitution, improvement, etc. made within the spirit and principles of the present disclosure shall be included in the scope of protection of the present disclosure.

1. A communication method between a test board and an optical module based on an I3C protocol, comprising:
S1, receiving, by the test board, an instruction sent by an upper computer;
S2, configuring a DMA channel of the test board and configuring an I3C bus;
S3, selecting, by the test board, a transmitting FIFO, adjusting a FIFO threshold according to a data volume of the instruction, and sending a write command to the optical module through the I3C bus in response to the instruction being a write instruction;
S4, performing, by the optical module, an operation according to the write command in response to receiving the write command;
S5, selecting, by the test board, a receiving FIFO, adjusting a FIFO threshold according to a data volume of the instruction, and sending a read command to the optical module through the I3C bus in response to the instruction being a read instruction;
S6, returning, by the optical module, data to the test board according to the read command in response to receiving the read command; and
S7, performing, by the test board, an error handling operation in response to the optical module not receiving the write command or the read command, or not receiving or outputting correct data.

2. The communication method between a test board and an optical module based on an I3C protocol according to claim 1, wherein a step of configuring the DMA channel comprises:
S21, configuring, on the test board, a DMA channel at a transmit end of the I3C bus;
S211, configuring a DMA direction of the transmit end as memory to peripheral;
S212, configuring a source address mode of a transmitting DMA as self-increment mode;
S213, configuring a destination address mode of the transmitting DMA as fixed mode;
S22, configuring, on the test board, a DMA channel at a receive end of the I3C bus;
S221, configuring a DMA direction of the receive end as peripheral to memory;
S222, configuring a source address mode of a receiving DMA as fixed mode;
S223, configuring a destination address mode of the receiving DMA as self-increment mode;
S23, configuring a control end of the DMA channel of the test board;
S231, configuring a DMA direction of the transmit end as memory to peripheral;
S232, configuring a source address mode of a transmitting DMA as self-increment mode; and
S233, configuring a destination address mode of the transmitting DMA as fixed mode.

3. The communication method between a test board and an optical module based on an I3C protocol according to claim 2, wherein a step of configuring the I3C bus comprises:
S24, configuring the test board as an I3C controller;
S25, configuring a I3C bus timing;
S251, setting a communication bandwidth under I3C Pushpull mode;
S252, setting a communication bandwidth under I3C OpenDrain mode; and
S26, setting an SDA high-impedance function.

4. The communication method between a test board and an optical module based on an I3C protocol according to claim 1, wherein the I3C bus supports a dynamic bandwidth and rate adjustment function.

5. The communication method between a test board and an optical module based on an I3C protocol according to claim 1, wherein the step of selecting, by the test board, a transmitting FIFO, adjusting a FIFO threshold according to a data volume of the instruction comprises:
S31, receiving, by the test board, a write instruction sent by the upper computer through USB;
S32, determining whether the instruction is a small-data-volume write instruction for control or testing;
S321, setting, by the test board, the transmitting FIFO threshold to 1 byte and initiating a small-data-volume write transmission in response to the instruction being a small-data-volume write instruction;
S3211, automatically determining, by hardware, whether the transmitting FIFO has at least 1 byte of free space, and initiating a DMA transferring one byte from a source address to the transmitting FIFO in response to the transmitting FIFO having at least 1 byte of free space;
S3212, determining whether the transfer is correct;
S32121, determining whether the transfer is completed in response to the transfer being correct;
S321211, returning to S3211 in response to the transfer not being completed;
S321212, continuing to wait for a next instruction in response to the transfer being completed;
S32122, performing the error handling operation of S7 in response to the transfer not being correct;
S322, setting, by the test board, the transmitting FIFO threshold to 4 bytes and initiating a large-data-volume write instruction transmission in response to the instruction being a large-data-volume write instruction for firmware updating;
S3221, automatically determining, by hardware, whether the transmitting FIFO has at least4 bytes of free spaces, and initiating a DMA transferring four bytes from a source address to the transmitting FIFO in response to the transmitting FIFO having at least 4 bytes of free spaces;
S3222, determining whether the transfer is correct;
S32221, determining whether the transfer is completed in response to the transfer being correct;
S322211, returning to S3221 in response to the transfer not being completed;
S322212, continuing to wait for a next instruction in response to the transfer being completed; and
S32222, performing the error handling operation of S7 in response to the transfer not being correct.

6. The communication method between a test board and an optical module based on an I3C protocol according to claim 5, wherein the write instruction further comprises a bulk firmware update instruction.

7. The communication method between a test board and an optical module based on an I3C protocol according to claim 6, wherein performing the bulk firmware update instruction comprises:
a, receiving, by the test board, the bulk firmware update instruction sent by the upper computer through USB;
b, checking whether a firmware to be downloaded already exists in an MCU Flash of the test board;
b1, performing following steps in response to the firmware to be downloaded existing in the MCU Flash of the test board:
b11, reading at most, from the Flash each time, a firmware frame having a maximum byte length of an EPL extended payload page in a CMIS protocol;
b12, performing CDB firmware updating based on the transmitting FIFO threshold of 4 bytes;
b13, repeating steps b11 and b12 based on a CDB protocol until a completion of the download; and
b2, performing following steps in response to the firmware to be downloaded not existing in the MCU Flash of the test board:
b21, preparing to receive a firmware sent by the upper computer and storing the firmware in the MCU Flash; and
b22, continuing to monitor subsequent bulk firmware download instructions.

8. The communication method between a test board and an optical module based on an I3C protocol according to claim 1, wherein the step of selecting, by the test board, a receiving FIFO, adjusting a FIFO threshold according to a data volume of the instruction comprises:
S51, receiving, by the test board, a read instruction sent by the upper computer through USB;
S52, determining whether the instruction is a small-data-volume read instruction;
S521, setting, by the test board, a receiving FIFO threshold to 1byte and initiating a small-data-volume read instruction transmission in response to the instruction being the small-data-volume read instruction for control or testing;
S5211, automatically determining, by hardware, whether the receiving FIFO has at least 1 byte of free space, and initiating a DMA transferring one byte from the receiving FIFO to a DMA destination address in response to the receiving FIFO having at least 1 byte of free space;
S5212, determining whether the transfer is correct;
S52121, determining whether the transfer is completed in response to the transfer being correct;
S521211, returning to S5211 in response to the transfer not being completed;
S521212, continuing to wait for a next instruction in response to the transfer being completed;
S52122, performing the error handling operation of S7 in response to the transfer not being correct;
S522, setting, by the test board, the receiving FIFO threshold to 4 bytes and initiating a large-data-volume read instruction transmission in response to the instruction being a large-data-volume read instruction for firmware updating;
S5221, automatically determining, by hardware, whether the receiving FIFO has at least 4 bytes of free spaces, and initiating a DMA transferring four bytes from the receiving FIFO to the DMA destination address in response to the receiving FIFO having at least 4 bytes of free spaces;
S5222, determining whether the transfer is correct;
S52221, determining whether the transfer is completed in response to the transfer being correct;
S522211, returning to S5221 in response to the transfer not being completed;
S522212, continuing to wait for a next instruction in response to the transfer being completed; and
S52222, performing the error handling operation of S7 in response to the transfer not being correct.

9. The communication method between a test board and an optical module based on an I3C protocol according to claim 1, wherein a step of performing the error handling operation comprises:
clearing a transmitting FIFO of the I3C, clearing a receiving FIFO of the I3C, clearing FIFO threshold adjustments, disabling requests of a DMA control end, disabling a transmitting DMA request, disabling a receiving DMA request, and reinitializing the I3C, wherein the steps are performed sequentially.

10. The communication method between a test board and an optical module based on an I3C protocol according to claim 9, wherein the I3C controller determines whether a triggering condition of the error handling operation occurs, and a MCU of the test board executes the error handling operation automatically in response to the triggering condition occurring.

11. The communication method between a test board and an optical module based on an I3C protocol according to claim 1, wherein the I3C generates communication frames comprising random write, random read, and current read, and the optical module receives or outputs data according to corresponding communication frame timing, in response to the test board sending the write command or the read command to the optical module through the I3C bus.

12. The communication method between a test board and an optical module based on an I3C protocol according to claim 11, wherein a frame format of the random write is: start bit + optical module address + write flag bit + optical module acknowledge bit + optical module register address + parity bit + data 1 + parity bit + … + data N + parity bit + stop bit.

13. The communication method between a test board and an optical module based on an I3C protocol according to claim 11, wherein a frame format of the random read is: start bit + optical module address + write flag bit + optical module acknowledge bit + optical module register address + parity bit + repeated start bit + optical module address + read flag bit + optical module acknowledge bit + data 1 + frame termination bit + … + data N + frame termination bit + stop bit.

14. The communication method between a test board and an optical module based on an I3C protocol according to claim 11, wherein a frame format of the current read is: start bit + optical module address + read flag bit + optical module acknowledge bit + data 1 + frame termination bit + … + data N + frame termination bit + stop bit.

15. A communication system between a test board and an optical module based on an I3C protocol, configured to implement the communication method between a test board and an optical module based on an I3C protocol according to claim 1, comprising the upper computer, the test board, and multiple optical modules, wherein the upper computer is in signal connection to the test board through USB, and the test board is communicatively connected to the multiple optical modules through the I3C bus.
